(19) United States
(12) Patent Application Publication
(10) Pub. No.: US 2012/0039068 A1
(43) Pub. Date: Feb. 16, 2012

(54) DISPLAY DEVICE

(75) Inventors: CHAO-CHANG LEE, Tu-Cheng (TW); YUAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/096,216

(22) Filed: Apr. 28, 2011

(30) Foreign Application Priority Data
Aug. 12, 2010 (CN) 201010251810.6

(51) Int. Cl. G09F 13/04

(52) U.S. Cl. 362/97.1

(57) ABSTRACT

A display device includes a bottom housing, a backlight module, and a display panel. The bottom housing includes a base and a frame integrally formed with the base. The frame includes a plurality of sidewalls connected with each other which cooperatively define a receiving space. The backlight module and the display panel are received in the receiving space. The display panel is fixed to the frame and placed on top of the backlight module.

### BACKGROUND

1. Technical Field

The present disclosure relates generally to display devices, more particularly, to a display device including a bottom housing.

2. Description of Related Art

A display device includes a display panel that displays image information, and a backlight module that provides light to the display panel. The backlight module includes a light source, a light guide plate, a reflecting sheet, a prism sheet, a diffusion sheet, a fixing frame and a plastic frame. The light source is placed beside the light guide plate. The reflecting sheet is placed below the light guide plate. The prism sheet, the diffusion sheet and the display panel are stacked on the light guide plate in that order. The fixing frame is configured to fix those components. The plastic frame is configured to shield the light emitting from the sides of the backlight module. However, the assembly process of the display device is complicated, and the display device is relatively thick because too many components are stacked together.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a display device.

FIG. 2 is an exploded, isometric view of the display device of FIG. 1 including a bottom housing, a backlight module, a plurality of cushion blocks, and a display panel.

FIG. 3 is an isometric view of the bottom housing of FIG. 1.

FIG. 4 is an enlarged view of a circled portion IV of FIG. 3.

FIG. 5 is a partial, enlarged, cross-section of the display device of FIG. 1, taken along line V-V.

FIG. 6 is a partial, enlarged, cross-section of the display device of FIG. 1, taken along line VI-VI.

### DETAILED DESCRIPTION

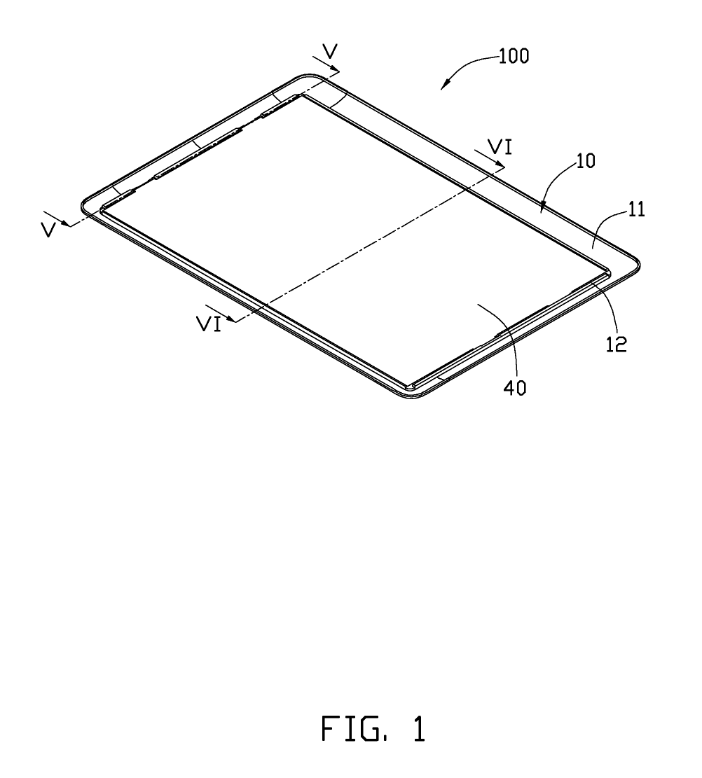

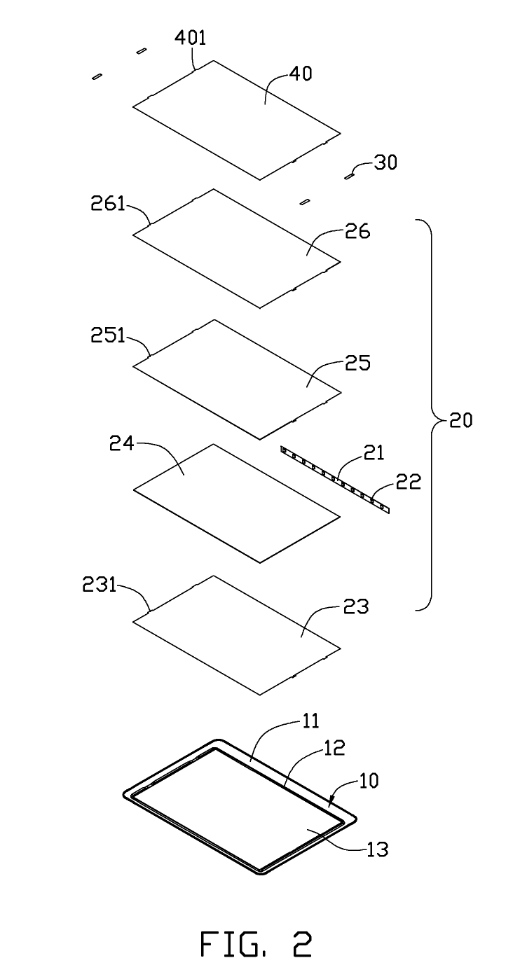

Referring to FIGS. 1 and 2, an embodiment of a display device 100 includes a bottom housing 10, a backlight module 20, a plurality of cushion blocks 30, and a display panel 40. The backlight module 20 is received in the bottom housing 10. The cushion blocks 30 are sandwiched between the backlight module 20 and the display panel 40.

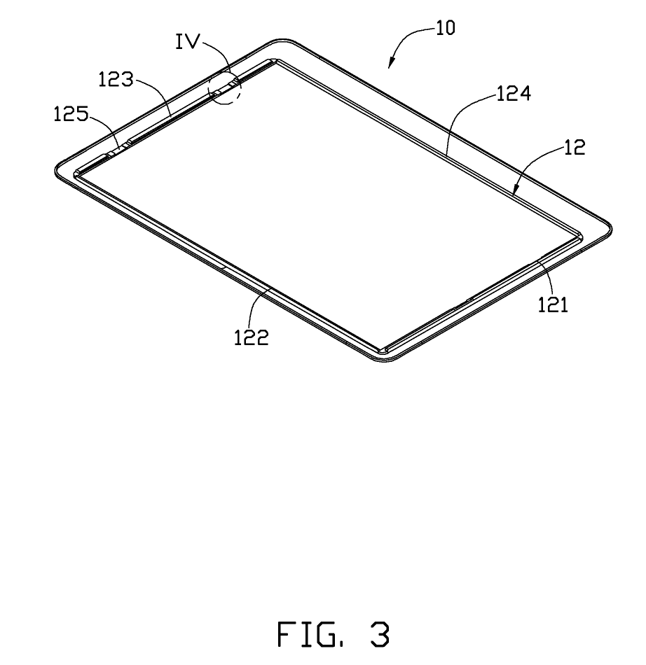

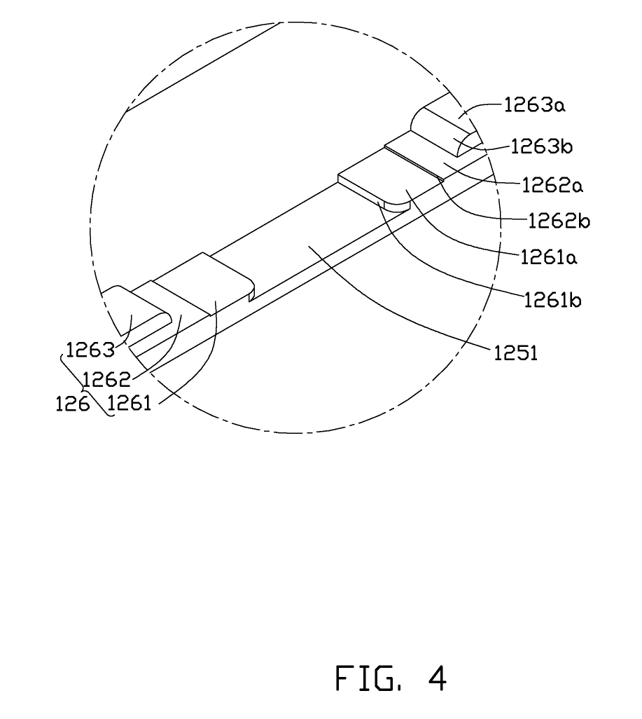

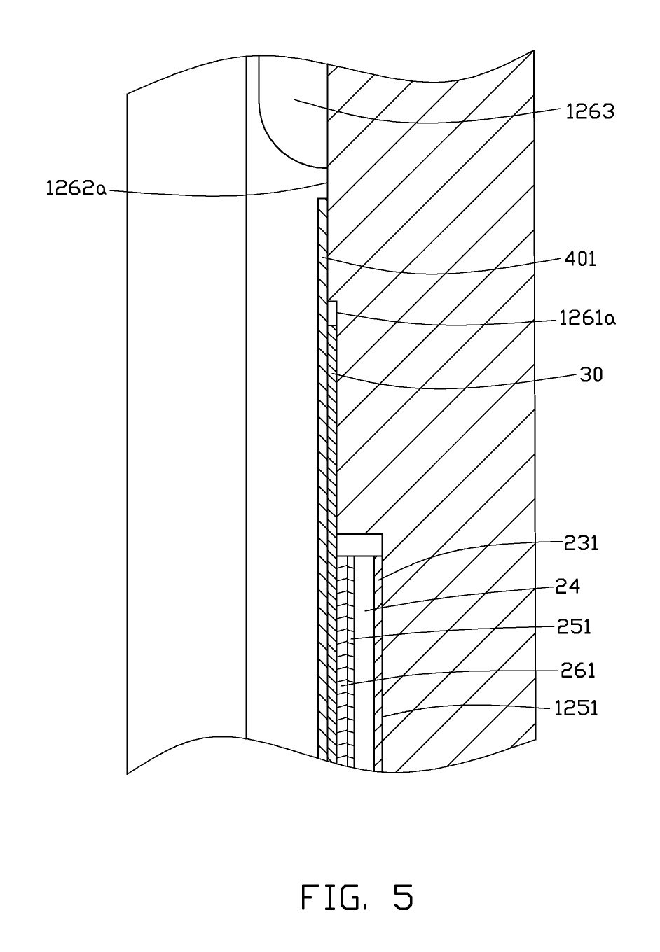

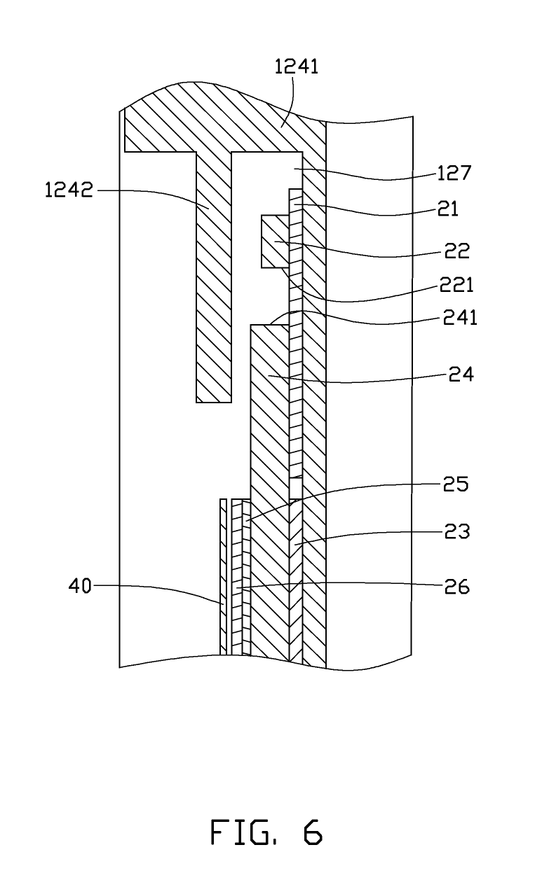

Referring to FIGS. 3 through 6, the bottom housing 10 includes a base 11 and a frame 12 integrally formed on the base 11. The frame 12 is substantially a rectangular frame, and includes a first sidewall 121, a second sidewall 122, a third sidewall 123, and a fourth sidewall 124, which cooperatively define a receiving space 13 to receive the backlight module 20 and the display panel 40. The first sidewall 121 is parallel to the third sidewall 123. The second sidewall 122 is parallel to the fourth sidewall 124. A plurality of fixing grooves 125 are defined on the first sidewall 121 and the third sidewall 123. In the illustrated embodiment, two fixing grooves 125 are defined on each of the first sidewall 121 and the third sidewall 123. The first sidewall 121 and the third sidewall 123 include a plurality of supporting walls 1251 and a plurality of supporting portions 126. Two supporting portions 126 are symmetrically placed on opposite sides of each supporting wall 1251, and define one fixing groove 125. Each supporting portion 126 includes a first supporting portion 1261, a second supporting portion 1262 and a third supporting portion 1263 stacked in that order. The first supporting portion 1261 includes a first supporting surface 1261a parallel to the supporting wall 1251, and a first end surface 1261b perpendicular to the first supporting surface 1261a. The second supporting portion 1262 includes a second supporting surface 1262a parallel to the supporting wall 1251, and a second end surface 1262b perpendicular to the second supporting surface 1262a. The third supporting portion 1263 includes a third supporting surface 1263a parallel to the supporting wall 1251, and a third end surface 1263b perpendicular to the third supporting surface 1263a. The distance between the two third end surfaces 1263b is greater than the distance between the two second end surfaces 1262b. The distance between the two second end surfaces 1262b is greater than the distance between the two first end surfaces 1261b. The fourth sidewall 124 includes a main body 1241, and an extending portion 1242 extending from the main body 1241 perpendicularly and toward the second sidewall 122. The extending portion 1242, the main body 1241, and the base 11 cooperatively define a receiving groove 127.

The backlight module 20 includes a flexible printed circuit board 21, a light source 22 fixed on the flexible printed circuit board 21, a reflecting sheet 23, a light guide plate 24, a prism sheet 25, and a diffusion sheet 26. The light source 22 includes an emitting surface. In the illustrated embodiment, the reflecting sheet 23 includes four first protrusions 231, which are placed on the opposite sides of the reflecting sheet 23, and correspond to the fixing grooves 125. The light guide plate 24 includes an incident surface 241. The prism sheet 25 includes four second protrusions 251, which are placed on opposite sides of the prism sheet 25, and correspond to the fixing grooves 125. The diffusion sheet 26 includes four third protrusions 261, which are placed on the two sides of the diffusion sheet 26, and correspond to the fixing grooves 125. The length of the first protrusion 231, the second protrusion 251, and the third protrusion 261 is equal to or smaller than the distance between the opposite first end surfaces 1261b.

The cushion block 30 is made of elastic material. In the illustrated embodiment, four cushion blocks 30 are disposed corresponding to the fixing grooves 125. The length of the cushion block 30 is equal to or smaller than the distance between the opposite second end surfaces 1262b.

In the illustrated embodiment, four fourth protrusions 401 are placed on opposite sides of the display panel 40, and correspond to the fixing grooves 125. The length of the fourth protrusion 401 is equal to or smaller than a distance between the opposite third end surfaces 1263b.

An assembly process of the display device 100 is described as follows. First, the light source 22 is fixed on the flexible printed circuit board 21, and then the flexible printed circuit board 21 together with the light source 22 are inserted into the receiving groove 127 and thermally bonded with the base 11 or adhered to the base 11 with adhesive. The reflecting sheet 23 is received in the receiving space 13, and the first protrusions 231 are correspondingly placed on the supporting walls 1251 of the fixing grooves 125. Second, the light guide plate 24 is inserted in the receiving groove 127, and positioned above on the flexible printed circuit board 21 and the reflecting sheet 23, then the emitting surface 221 of the light source 22 is placed corresponding to the incident surface 241 of the light guide plate 24, and the extending portion 1242 covers the light source 22 and the incident surface 241. The prism sheet 25 is placed on the light guide plate 24, and the second protrusions 251 are correspondingly positioned on the first protrusions 231. The diffusion sheet 26 is placed on the prism sheet 25, and the third protrusions 261 are correspondingly positioned on the second protrusion 251. Third, each cushion block 30 is placed on one third protrusion 261 and is correspondingly supported by the opposite first supporting surfaces 1261a. Finally, the display panel 40 is placed in the receiving space 13 and is adhered to the frame 12 with adhesive, and each fourth protrusion 401 of the display panel 40 is positioned on the cushion block 30 and is correspondingly supported by the opposite second supporting surfaces 1262a.

Because the display panel 40 is adhered to the frame 12 with adhesive and placed on the cushion blocks 30, and the backlight module 20 is sandwiched between the cushion blocks 30 and the base 11, the backlight module 20 is secured in the receiving space 13. Since the length of the first protrusion 231, the second protrusion 251, and the third protrusion 261 is equal to or smaller than the distance between the opposite first end surfaces 1261b, the length of the cushion block 30 is equal to or smaller than the distance between the opposite second end surfaces 1262b, and the length of the fourth protrusions 401 is equal to or smaller than the distance between the opposite third end surfaces 1263b, there is no force exerted between the reflecting sheet 23, the light guide plate 24, the prism sheet 25, the diffusion sheet 26, the cushion blocks 30, the display panel 40 and the end surfaces, and thereby the assembly process of the display device 100 is easier, and also the above-mentioned components cannot be easily damaged during assembly. Because the cushion blocks 30 are made of elastic material, and are sandwiched between the display panel 40 and the backlight module 20, the cushion blocks 30 can fix or retain the backlight module 20 and protect the display panel 40 from being damaged by a force generated between the display panel 40 and the backlight module 20.

In the alternative embodiments, one or more than two fixing grooves 125 may be defined in one sidewall of the frame 12. One or more than two first protrusions 231, second protrusions 251, third protrusions 261, cushion blocks 30 and fourth protrusions 401 may be correspondingly employed, respectively. The receiving groove 127 may be defined in the first sidewall 121, the third sidewall 123 or the fourth sidewall 124, and in addition, the receiving groove 127 may employ other structures. Furthermore, no fixing groove 125 or receiving groove 127 may be defined in the sidewalls of the frame 12, while an elastic latching portion placed on the frame 12 may be used to fix or retain the backlight module 20, and the display panel 40 may be positioned on the frame 12 and fixed to the bottom housing 10.

Because the frame 12 which is integrally formed with the base 11 is used to fix the backlight module 20 and display panel 40 together, and the sidewalls of the frame 12 can enclose the backlight module 20, therefore, the light from the sidewalls of the backlight module 20 is shielded, and thereby special fixing frame is not needed to fix the backlight module 20 and the display panel 40 together, and special plastic frame is not needed to shield the light from the sidewalls of the backlight module 20, such that the display device 100 has less components, a thinner structure and an easier assembly process.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A display device, comprising:
a bottom housing, the bottom housing comprising a base and a frame integrally formed with the base, wherein the frame comprises a plurality of sidewalls connected with each other, and cooperatively define a receiving space;
a backlight module received in the receiving space; and
a display panel received in the receiving space, wherein the display panel is fixed to the frame and placed on a top of the backlight module.

2. The display device of claim 1, wherein at least one fixing groove is defined in opposite sidewalls of the plurality of sidewalls of the frame, the backlight module and the display panel comprise at least one protrusion corresponding to the at least one fixing groove and received in the at least one fixing groove, and the at least one protrusion of the display panel is placed over the at least one protrusion of the backlight module.

3. The display device of claim 2, wherein each sidewall of the frame comprises a plurality of supporting walls and a plurality of supporting portions, two supporting portions are placed symmetrically on the opposite sides of each supporting wall, and define one of the at least one fixing groove.

4. The display device of claim 3, wherein each supporting portion comprises a supporting surface on which each corresponding protrusion of the display panel is correspondingly placed, and the at least one protrusion of the backlight module is correspondingly placed on the supporting wall.

5. The display device of claim 4, wherein the display device further comprises at least one cushion block, and each cushion block is placed on the supporting surface and is sandwiched between the protrusions of the backlight module and each protrusion of the display panel.

6. The display device of claim 5, wherein the supporting portions comprise a first supporting portion, a second supporting portion and a third supporting portion stacked in that order, the first supporting portion comprises a first supporting surface parallel to the supporting wall, the second supporting portion comprises a second supporting surface parallel to the supporting wall, and the third supporting portion comprises a third supporting surface parallel to the supporting wall, respectively, each cushion block is correspondingly placed on the opposite first supporting surfaces, each protrusion of the display panel is correspondingly placed on the opposite second supporting surfaces, a distance between the two third end surfaces is greater than the distance between the two second end surfaces, and a distance between the two second end surfaces is greater than the distance between the two first end surfaces.

7. The display device of claim 1, wherein the backlight module comprises a flexible printed circuit board, a light source fixed on the flexible printed circuit board, a reflecting sheet, a light guide plate, a prism sheet, and a diffusion sheet, the light guide plate is placed on the reflecting sheet, the diffusion sheet is placed on the prism sheet, and the prism sheet is sandwiched between the light guide plate and the diffusion sheet.

8. The display device of claim 7, wherein a receiving groove is defined in the frame, the flexible printed circuit board together with the light source are inserted and fixed in the receiving groove, and a part of the light guide plate is inserted in the receiving groove and adjacent to the light source.

9. The display device of claim 8, wherein the flexible printed circuit board is thermally bonded with the base or adhered to the base with adhesive.

10. The display device of claim 1, wherein the display panel is adhered to the frame with adhesive.
